(19) United States
(12) Patent Application Publication
(10) Pub. No.: US 2026/0289629 A1
(43) Pub. Date: Sep. 24, 2026

(54) ARTIFICIAL INTELLIGENCE BASED RECOMMENDATION OF HARMONIZED SYSTEM CODE OR OTHER CLASSIFICATION CODE

(71) Applicant: Logistics and Supply Chain MultiTech R&D Centre Limited, Pok Fu Lam (HK)

(72) Inventors: Chi Hung Tong, Pok Fu Lam (HK); . Budianto, Pok Fu Lam (HK); Lap Fai Yuen, Pok Fu Lam (HK)

(21) Appl. No.: 19/088,130

(22) Filed: Mar. 24, 2025

(51) Int. Cl. G06Q 30/0601

(52) U.S. Cl. CPC G06Q 30/0625

(57) ABSTRACT

Artificial intelligence based recommendation of classification code such as Harmonized System (HS) code. A textual prompt associated with a good or a service is received. Information for classifying the good or the service is retrieved based at least in part of the textual prompt. An input for a natural language processing model is generated based at least in part on the textual prompt and the retrieved information. An output, which includes at least one recommended classification code of the good or the service, is obtained based at least in part on applying the input to the natural language processing model. The at least one recommended classification code of the good or the service is output. The classification code may include an HS Code associated with a good.

### TECHNICAL FIELD

This invention relates to artificial intelligence (AI) based recommendation of Harmonized System (HS) Code or other classification code.

### BACKGROUND

Classification systems are used in various fields, including trade, economics, healthcare, and information management. Typically, a classification system uses classification codes, such as standardized numerical or alphanumeric codes, to organize or categorize entities (such as goods, products, services, etc.) based on their characteristics or attributes.

Examples of these classification systems include the HS developed by the World Customs Organization (WCO), the Central Product Classification (CPC) system developed by the United Nations (UN), the North American Industry Classification System (NAICS), etc.

Some classification systems may be complex in that they use various categories, subcategories, and code structures. Some classification systems may be updated from time to time to reflect change in regulations, change in standards, advancements, etc. Some classification systems may have different classifications or interpretations for different countries or regions. For one or more of these reasons (among others), the determination of a classification code of an entity can be complicated and time-consuming.

### SUMMARY

In a first aspect, there is provided a Harmonized System (HS) Code recommendation system comprising one or more processors configured to: receive a textual prompt associated with a good; retrieve information for classifying the good based at least in part of the textual prompt; generate an input for a natural language processing model based at least in part on the textual prompt and the retrieved information; obtain an output based at least in part on applying the input to the natural language processing model, the output comprising at least one recommended HS Code of the good; and output the at least one recommended HS Code of the good. The good may be a commodity or a product.

The textual prompt may include a question or a sentence (not question). In one embodiment of the first aspect, the textual prompt comprises a description of the good. In one embodiment of the first aspect, the textual prompt comprises one or more keywords related to the good. In one embodiment of the first aspect, the textual prompt further comprises a country or territory of interest associated with the recommendation.

The information for classifying the good is retrieved from an information source such as one or more database. In one embodiment of the first aspect, the information source comprises HS Codes information indexed based at least in part on a trie (prefix tree) data structure. In one embodiment of the first aspect, the information source comprises HS information source, which comprises World Customs Organization (WCO) HS Codes information. In one embodiment of the first aspect, the information is retrieved at least in part from the WCO Explanatory Notes. In one embodiment of the first aspect, the information source comprises one or more country- or territory- specific HS Codes information. In one embodiment of the first aspect, the information source comprises national or territorial tariff or customs information associated with country- or territory- specific HS Codes.

In one embodiment of the first aspect, the natural language processing model comprises a large language model (LLM).

In one embodiment of the first aspect, the one or more processors are configured to, for each of the at least one recommended HS Code of the good: retrieve a corresponding description of the recommended HS Code of the good, and output the corresponding description of the recommended HS Code of the good.

In one embodiment of the first aspect, the one or more processors are configured to: receive the textual prompt based at least in part on processing an image comprising the good.

In one embodiment of the first aspect, the recommended HS Code is a 6-digit code. The 6-digit code is an internationally standardized HS Code.

In one embodiment of the first aspect, the HS Code is an 8-digit code. The 8-digit code is an internationally standardized HS Code plus a national/regional specific classification code.

In one embodiment of the first aspect, the recommended HS Code is a 10-digit code. The 10-digit code is an internationally standardized HS Code plus a national/regional specific classification code.

In a second aspect, there is provided a classification code recommendation system, comprising one or more processors configured to: receive a textual prompt associated with a good or a service; retrieve information for classifying the good or the service based at least in part of the textual prompt; generate an input for a natural language processing model based at least in part on the textual prompt and the retrieved information; obtain an output based at least in part on applying the input to the natural language processing model, the output comprising at least one recommended classification code of the good or the service; and output the at least one recommended classification code of the good or the service. The recommended classification code may be a numerical or alphanumeric code.

The textual prompt may include a question or a sentence (not question). In one embodiment of the second aspect, the textual prompt comprises a description of the good or the service. In one embodiment of the second aspect, the textual prompt comprises one or more keywords related to the good or the service. In one embodiment of the second aspect, the textual prompt comprises a country or territory of interest associated with the recommendation.

The information for classifying the good or the service is retrieved from an information source such as one or more database.

In one embodiment of the second aspect, the information for classifying the good or the service is retrieved from an information source comprising classification codes information indexed based at least in part on a trie data structure.

In one embodiment of the second aspect, the natural language processing model comprises a large language model (LLM).

In one embodiment of the second aspect, the one or more processors are configured to, for each of the at least one recommended classification code of the good or the service: retrieve a corresponding description of the recommended classification code of the good or the service; and output the corresponding description of the recommended classification code of the good or the service.

In one embodiment of the second aspect, the one or more processors are configured to: receive the textual prompt based at least in part on processing an image comprising the good or the service.

In a third aspect, there is provided a Harmonized System (HS) Code recommendation method comprising: receiving a textual prompt associated with a good; retrieving information for classifying the good based at least in part of the textual prompt; generating an input for a natural language processing model based at least in part on the textual prompt and the retrieved information; obtaining an output based at least in part on applying the input to the natural language processing model, the output comprising at least one recommended HS Code of the good; and outputting the at least one recommended HS Code of the good. The good may be a commodity or a product.

The textual prompt may include a question or a sentence (not question). In one embodiment of the third aspect, the textual prompt comprises a description of the good. In one embodiment of the third aspect, the textual prompt comprises one or more keywords related to the good. In one embodiment of the third aspect, the textual prompt further comprises a country or territory of interest associated with the recommendation.

The information for classifying the good is retrieved from an information source such as one or more database. In one embodiment of the third aspect, the information source comprises HS Codes information indexed based at least in part on a trie (prefix tree) data structure. In one embodiment of the third aspect, the information source comprises HS information source which comprises World Customs Organization (WCO) HS Codes information. In one embodiment of the third aspect, the information is retrieved at least in part from the WCO Explanatory Notes. In one embodiment of the third aspect, the information source comprises one or more country- or territory- specific HS Codes information. In one embodiment of the third aspect, the information source comprises national or territorial tariff or customs information associated with country- or territory- specific HS Codes.

In one embodiment of the third aspect, the natural language processing model comprises a large language model (LLM).

In one embodiment of the third aspect, the method comprises: for each of the at least one recommended HS Code of the good, retrieving a corresponding description of the recommended HS Code of the good, and outputting the corresponding description of the recommended HS Code of the good.

In one embodiment of the third aspect, the method comprises: receiving the textual prompt based at least in part on processing an image comprising the good.

In one embodiment of the third aspect, the recommended HS Code is a 6-digit code. The 6-digit code is an internationally standardized HS Code.

In one embodiment of the third aspect, the HS Code is an 8-digit code. The 8-digit code is an internationally standardized HS Code plus a national/regional specific classification code.

In one embodiment of the third aspect, the recommended HS Code is a 10-digit code. The 10-digit code is an internationally standardized HS Code plus a national/regional specific classification code.

In a fourth aspect, there is provided a carrier medium carrying computer readable instructions arranged to cause a computer to perform or to facilitate performing of the method of the third aspect. In one example, the carrier medium comprises a computer-readable medium. In one example, the computer-readable medium is a non-transitory computer-readable storage medium, which stores a computer program configured to be executed by a computer. The computer program comprises instructions for performing or for facilitating performing of the method of the third aspect.

In a fifth aspect, there is provided a computer program comprising instructions which, when the program is executed by a computer, cause the computer to carry out the method of the third aspect.

In a sixth aspect, there is provided a classification code recommendation method comprising: receiving a textual prompt associated with a good, a related service or a service; retrieving information for classifying the good or the service based at least in part of the textual prompt; generating an input for a natural language processing model based at least in part on the textual prompt and the retrieved information; obtaining an output based at least in part on applying the input to the natural language processing model, the output comprising at least one recommended classification code of the good or the service; and outputting the at least one recommended classification code of the good or the service.

The textual prompt may include a question or a sentence (not question). In one embodiment of the sixth aspect, the textual prompt comprises a description of the good or the service. In one embodiment of the sixth aspect, the textual prompt comprises one or more keywords related to the good or the service. In one embodiment of the sixth aspect, the textual prompt comprises a country or territory of interest associated with the recommendation.

The information for classifying the good or the service is retrieved from an information source such as one or more database. The recommended classification code may be a numerical or alphanumeric code.

In one embodiment of the sixth aspect, the information for classifying the good or the service is retrieved from an information source comprising classification codes information indexed based at least in part on a trie data structure.

In one embodiment of the sixth aspect, the natural language processing model comprises a large language model (LLM).

In one embodiment of the sixth aspect, the method comprises: for each of the at least one recommended classification code of the good or the service, retrieving a corresponding description of the recommended classification code of the good or the service, and outputting the corresponding description of the recommended classification code of the good or the service.

In one embodiment of the sixth aspect, the method comprises: receiving the textual prompt based at least in part on processing an image comprising the good or the service.

In a seventh aspect, there is provided a carrier medium carrying computer readable instructions arranged to cause a computer to perform or to facilitate performing of the method of the sixth aspect. In one example, the carrier medium comprises a computer-readable medium. In one example, the computer-readable medium is a non-transitory computer-readable storage medium, which stores a computer program configured to be executed by a computer. The computer program comprises instructions for performing or for facilitating performing of the method of the sixth aspect.

In an eighth aspect, there is provided a computer program comprising instructions which, when the program is executed by a computer, cause the computer to carry out the method of the sixth aspect.

Other features and aspects will become apparent by consideration of the following detailed description and the accompanying drawings. Any feature(s) described herein in relation to one aspect or embodiment may be combined with any other feature(s) described herein in relation to any other aspect or embodiment, as appropriate and applicable.

### BRIEF DESCRIPTION OF THE DRAWINGS

Some embodiments of the invention will now be described, with reference to the accompanying drawings, in which:

FIG. 1 is a flowchart illustrating a HS Code recommendation method in one embodiment;

FIG. 2A is a schematic diagram illustrating operation of a HS Code recommendation system in one embodiment;

FIG. 2B is a schematic diagram illustrating operation of a HS Code recommendation system in another embodiment;

FIG. 3 is a flowchart illustrating a classification code recommendation method in one embodiment;

FIG. 4A is a schematic diagram illustrating operation of a classification code recommendation system in one embodiment;

FIG. 4B is a schematic diagram illustrating operation of a classification code recommendation system in another embodiment; and

FIG. 5 is a block diagram of an information processing system in one embodiment.

### DETAILED DESCRIPTION

Some embodiments disclosed herein relate to AI based tool that can be used for recommending HS Code.

The HS Code belongs to the Harmonized System, which is a specialized system used in over 200 countries worldwide for classifying goods (e.g., commodities, products). An HS Code is a numerical code that typically includes 6 to 10 digits. Generally, the first 6 digits of a HS Code is used internationally and is standardized by the World Customs Organization (WCO). For some nations or regions, the HS Code may include additional digits for more specific classification in national/regional level. Typically, to determine or find the HS Code of a good, it would be necessary to refer to various rules, definitions, decisions, etc., from various sources.

It is known that manual HS Code identification is challenging especially for an untutored individual. Further, it has been found that the automation of HS Code identification is not straightforward. In view of these, some embodiments disclosed herein enable automatic identification of HS Code for goods (the HS Code may include the WCO-standardized 6 digits and optionally a nation or region specific suffix (e.g., 4 additional digits for China imports)).

Manual determination of an HS Code, even only for the initial 6 digits, is a complex process, especially for an untrained individual. This is because to assign the correct HS Code, one may have to navigate a hierarchical classification system by identifying and applying various general and specific rules, to extract the categorization 2 digits at a time. Beyond locating the relevant listings, one may have to consult various notes and publications that clarify terminology, define distinctions, specify exclusions, and provide guidance on ruling out similar alternatives. Some of these notes and publications are scattered across multiple chapters within the official WCO Explanatory Notes, which is regularly updated and may not be available online. Occasionally, additional notes and documents such as classification decisions may need to be considered. Further, for HS Codes with mode than 6 digits, e.g., 10 digits, one may have to consult even less accessible national or regional specific sources, such as customs reference publications, online taxation references, and customs classification decision announcements. As a result, the cognitive load on one who seeks to determine the HS Code is quite significant. While some existing websites or publications do provide static HS Code listings, these resources lack the higher-level rules, precautionary notes such as precedence guidelines, and contextual information necessary for accurate determination of HS Code based on the notes and exceptions. Thus, the process of manual HS Code determination or identification is error-prone, especially for one who is unfamiliar with the system or the workflow.

Automation of HS Code identification may address the above problems associated with manual determination. Indeed, the automating the HS Code identification process is important especially in the era of booming e-commerce and global trade. With the proliferation of cross-border transactions, customs authorities are struggling to cope with the sheer volume of processing and disputes efficiently. Inaccurate HS Code assignment may lead to severe financial, operational, and/or reputational consequences for businesses engaged in global trade. In terms of HS Code determination, currently, most countries report a slightly higher than 70% accuracy rate. This implies that 30% of goods are misclassified, and this may result in losses in collectable tariffs worldwide. Misclassified goods may trigger customs inspections, leading to clearance delays that disrupt supply chains, impacting inventory levels, sales, and overall operations, hence risking customer dissatisfaction and reputational damage. Revenue losses stem from underpayment or overpayment of duties and taxes, compounded by potential fines for non-compliance. Further, HS Code errors complicate adherence to trade agreements and regulations, limiting market access and inviting legal action. And resolving misclassification may require costly audits, reassessments, and specialized consultations, hence draining administrative resources.

The development of an automatic HS Code identification tool is challenging for various reasons. For example, to cope with the diverse workflow patterns implicated in identifying a HS Code, the tool must be able to switch tasks and selection appropriate reference sources and perform classifications automatically based on the user query, and yet the combination of rule-based and classification tasks in the same tool is difficult to achieve. For example, as some reference data may be in structured text format whereas some other reference data may be written as unstructured text instructions, the tool needs to be able to process both structured and unstructured reference text sources. For example, the accuracy for a longer 10-digit HS Code would be lower than a shorter 6-digit HS Code as there is much less data available for facilitating the determination of a longer HS code and generic application of machine learning may not be able to address this problem. For example, the tool may need to have rapid updatability without requiring model re-training. Specifically, as the WCO or various national or regional specific Customs Departments may introduce changes (e.g., every five years, ad hoc rapid changes over months or annually to accommodate changes due to sanctions, environmental factors and product trends/evolution), the tool needs to be rapidly updatable to avoid misclassification and to maintain accuracy. Ideally, the tool should be able to provide commercial level accuracy (e.g. above 90%) for full HS Code elucidation, depending on the country specific requirements, with pertinent explanation and substantially real-time performance. Ideally, the automatic HS Code identification tool should achieve high accuracy, explainability, and high processing speed for real world adoption.

Some embodiments disclosed herein relate to AI based tool that can be used for recommending HS Code.

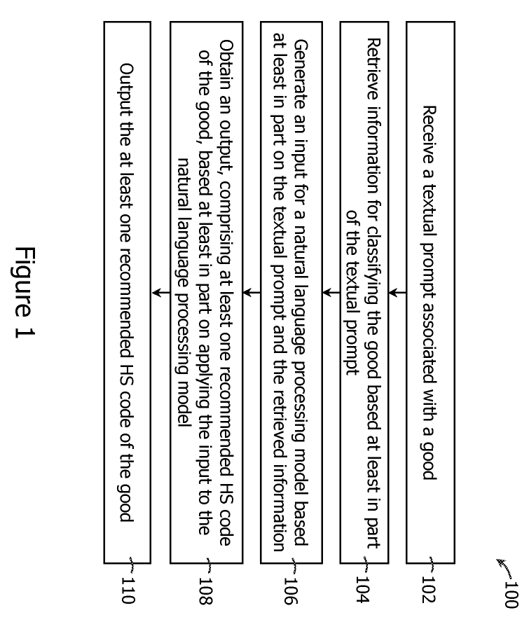

FIG. 1 shows a HS Code recommendation method 100 in one embodiment. The method 100 can be performed by one or more processors.

The method 100 includes, in 102, receiving a textual prompt associated with a good. The good may be a commodity or a product. The textual prompt may include a question or a sentence (not question). The textual prompt may include a description of the good, or one or more keywords related to the good. The textual prompt may further include a country or territory of interest associated with the recommendation.

The method 100 includes, in 104, retrieving information for classifying the good based at least in part of the textual prompt. The information may be retrieved from an information source such as one or more database. The database may include a vector database. The database may be associated with information that can be used for classifying the good. For example, the information source may include HS Codes information indexed based at least in part on a trie (prefix tree) data structure. For example, the information source may include HS information source, which may include World Customs Organization (WCO) HS Codes information. For example, the information may be retrieved at least in part from the WCO Explanatory Notes. Additionally or alternatively, the information source may include one or more country- or territory- specific HS Codes information. For example, the information source may include national or territorial tariff or customs information associated with country- or territory- specific HS Codes.

The method 100 includes, in 106, generating an input for a natural language processing model based at least in part on the textual prompt and the retrieved information. The natural language processing model may include or may be a large language model (LLM). The input can then be provided to the natural language processing model for processing and for generating an output.

The method 100 includes, in 108, obtaining an output based at least in part on applying the input to the natural language processing model. The output includes at least one recommended HS Code of the good. For example, each recommended HS Code may be a 6-digit code, an 8-digit code, or a 10-digit code.

The method 100 includes, in 110, outputting the at least one recommended HS Code of the good, e.g., for presenting the at least one recommended HS Code to a user.

One skilled in the art appreciates that method 100 is merely an example and that various modifications and/or variations to method 100 to provide other embodiments. For example, the method 100 may further include, for each of the at least one recommended HS Code of the good: retrieving a corresponding description of the recommended HS Code of the good, and outputting the corresponding description of the recommended HS Code of the good. The description of the recommended HS Code may be output along with the corresponding recommended HS code. For example, the method 100 may further include retrieving the textual prompt based at least in part on processing an image comprising the good. For example, an image of the good may be captured and the image may be processed using AI or computer vision techniques to determine text associated with the good in the image.

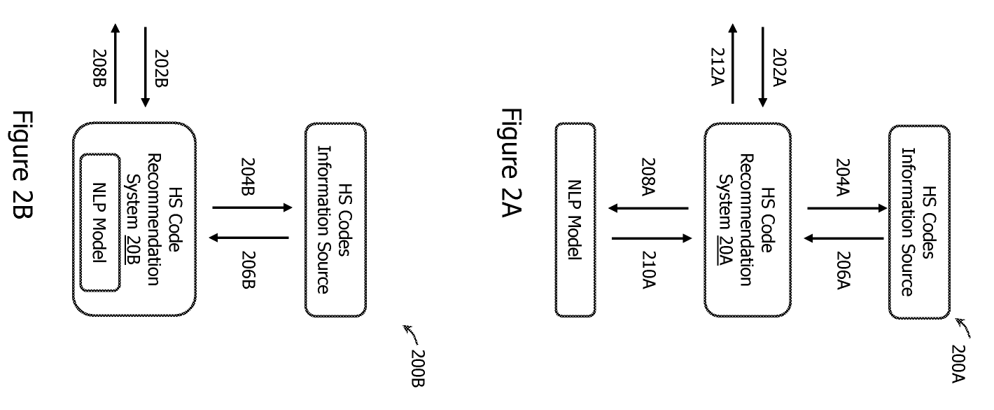

FIG. 2A illustrates operation 200A of a HS Code recommendation system 20A in one embodiment. The HS Code recommendation system 20A may be implemented using at least one or more processors.

In 202A, the HS Code recommendation system 20A receives a textual prompt associated with a good. This may correspond to 102 in method 100.

In 204A, the HS Code recommendation system 20A, based on the received textual prompt, transmits an information retrieval request to a HS Codes information source (one or more database such as vector database).

In 206A, the HS Codes information source obtains the corresponding information for classifying the good and provides the information to the HS Code recommendation system 20A. In other words, the HS Code recommendation system 20A retrieves information for classifying the good from the HS Codes information source. This may correspond to 104 in method 100.

The HS Code recommendation system 20A then generates an input for a natural language processing (NLP) model based on the textual prompt and the retrieved information. This may correspond to 106 in method 100.

In 208A, the HS Code recommendation system 20A provides the input to the natural language processing model. The natural language processing model processes the input and generates an output. The output includes at least one recommended HS Code of the good.

In 210A, the natural language processing model provides the output to the HS Code recommendation system 20A, and the HS Code recommendation system 20A accordingly obtains the output which includes the at least one recommended HS Code of the good. This may correspond to 108 in method 100.

In 212A, the HS Code recommendation system 20A outputs the at least one recommended HS Code of the good. This may correspond to 110 in method 100.

One skilled in the art appreciates that operation 200A is merely an example and that various modifications and/or variations to operation 200A to provide other embodiments.

FIG. 2B illustrates operation 200B of a HS Code recommendation system 20B in one embodiment. The HS Code recommendation system 20B may be implemented using at least one or more processors.

The HS Code recommendation system 20B is generally the same as the HS Code recommendation system 20A, except that the HS Code recommendation system 20B includes the natural language processing model.

In 202B, the HS Code recommendation system 20B receives a textual prompt associated with a good. This may correspond to 102 in method 100.

In 204B, the HS Code recommendation system 20B, based on the received textual prompt, transmits an information retrieval request to a HS Codes information source (one or more database such as vector database).

In 206B, the HS Codes information source obtains the corresponding information for classifying the good and provides the information to the HS Code recommendation system 20B. In other words, the HS Code recommendation system 20B retrieves information for classifying the good from the HS Codes information source. This may correspond to 104 in method 100.

The HS Code recommendation system 20B then generates an input for a natural language processing model based on the textual prompt and the retrieved information. This may correspond to 106 in method 100. The HS Code recommendation system 20B feeds the input to the natural language processing model. The natural language processing model processes the input and generates an output. The output includes at least one recommended HS Code of the good. The HS Code recommendation system 20B obtains the output which includes the at least one recommended HS Code of the good. This may correspond to 108 in method 100.

In 208B, the HS Code recommendation system 20B outputs the at least one recommended HS Code of the good. This may correspond to 110 in method 100.

One skilled in the art appreciates that operation 200B is merely an example and that various modifications and/or variations to operation 200B to provide other embodiments.

Some example implementations of the AI based tool for recommending HS Code involve the use of large language model (LLM), with retrieval augmented generation and trie data structure. Some example implementations of the AI based tool leverage the versatile tasks switching, rule following, and classification abilities of LLMs to address the challenges associated with the development of an automatic HS Code identification tool. For example, the LLM has rule following abilities. The LLM may combine task switching, rule following and classification, including terminology distinctions, exclusions, and which are useful for interpreting the HS Code Explanatory Notes (and other information useful for determining HS Code). For example, combined with retrieval augmentation generation with entities and relationships, the LLM may handle unstructured text well and can answer per run time provided reference data to provide improved performance over traditional machine learning/ The LLM may provide pertinent explanation when suitably programmed / prompted. In some implementations, retrieval augmentation generation in the LLM can operate based on prompted knowledge instead of training, and can adapt to change in/updates to the HS Code system rapidly without the need for retraining. Near real-time incorporation of updated information sources and knowledge bases can allow the LLM to seamlessly adjust its recommendations to align with the latest HS Code revisions, product trends, and regulatory updates. In some implementations, the AI based tool for recommending HS Code can provide accurate (>90%) and explanations for 10-digit HS Code (e.g., for China import data). Some implementations include trie data structure as an efficient text retrieval structure. For example, some implementations integrate a trie (prefix tree) data structure, which is inherent in the design of the HS Code hierarchy. The trie (prefix tree) data structure data structure is particularly useful for storing and efficiently retrieving the HS Code rules, product descriptions, and related information with logarithmic speed in lookup time (for n matches, only log(n) needed for completion). The data structure allows the AI based tool to have computational performance advantage over above other approaches and can complement the use of LLM with retrieval augmentation generation.

Some embodiments disclosed herein relate to AI based tool that can be used for recommending other classification code.

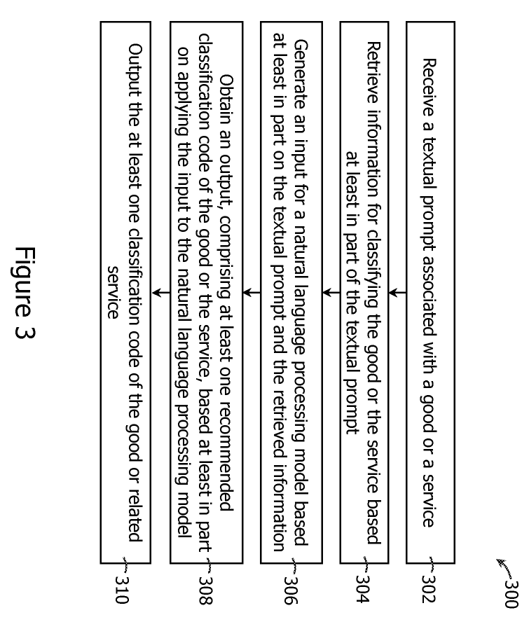

FIG. 3 shows a classification code recommendation method 300 in one embodiment. The method 300 can be performed by one or more processors.

The method 300 includes, in 302, receiving a textual prompt associated with a good, a related service or a service. The good may be a commodity or a product. The textual prompt may include a question or a sentence (not question). The textual prompt may include a description of the good, a related service or the service, or one or more keywords related to the good, a related service or the service. The textual prompt may further include a country or territory of interest associated with the recommendation.

The method 300 includes, in 304, retrieving information for classifying the good or the service based at least in part of the textual prompt. The information may be retrieved from an information source such as one or more database. The database may include a vector database. The information for classifying the good or the service may be retrieved from an information source comprising classification codes information indexed based at least in part on a trie data structure.

The method 300 includes, in 306, generating an input for a natural language processing model based at least in part on the textual prompt and the retrieved information. The natural language processing model may include or may be a large language model (LLM). The input can then be provided to the natural language processing model for processing and for generating an output.

The method 300 includes, in 308, obtaining an output based at least in part on applying the input to the natural language processing model. The output includes at least one recommended classification code of the good, a related service or the service. The recommended classification code may be a numerical or alphanumeric code.

The method 300 includes, in 310, outputting the at least one recommended classification code of the good, e.g., for presenting the at least one recommended classification code to a user.

One skilled in the art appreciates that method 300 is merely an example and that various modifications and/or variations to method 300 to provide other embodiments. For example, the method 300 may further include, for each of the at least one recommended classification code of the good or the service: retrieving a corresponding description of the recommended classification code of the good or the service, and outputting the corresponding description of the recommended classification code of the good or the service. The description of the recommended classification code may be output along with the corresponding recommended classification code. For example, the method 300 may further include retrieving the textual prompt based at least in part on processing an image comprising the good or an image illustrating the service. For example, an image of the good or the service may be captured, and the image may be processed using AI or computer vision techniques to determine text associated with the good or the service in the image.

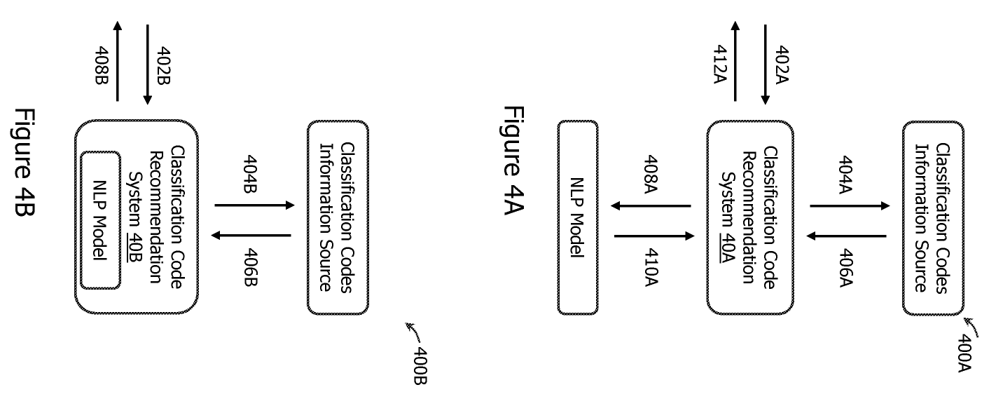

FIG. 4A illustrates operation 400A of a classification code recommendation system 40A in one embodiment. The classification code recommendation system 40A may be implemented using at least one or more processors.

In 402A, the classification code recommendation system 40A receives a textual prompt associated with a good or a service. This may correspond to 302 in method 300.

In 404A, the classification code recommendation system 40A, based on the received textual prompt, transmits an information retrieval request to a classification codes information source (one or more database such as vector database).

In 406A, the classification codes information source obtains the corresponding information for classifying the good or the service, and provides the information to the classification code recommendation system 40A. In other words, the classification code recommendation system 40A retrieves information for classifying the good or the service from the classification codes information source. This may correspond to 304 in method 300.

The classification code recommendation system 40A then generates an input for a natural language processing model based on the textual prompt and the retrieved information. This may correspond to 306 in method 300.

In 408A, the classification code recommendation system 40A provides the input to the natural language processing model. The natural language processing model processes the input and generates an output. The output includes at least one recommended classification code of the good or the service. The recommended classification code may be a numerical or alphanumeric code.

In 410A, the natural language processing model provides the output to the classification code recommendation system 40A, and the classification code recommendation system 40A accordingly obtains the output which includes the at least one recommended classification code of the good or the service. This may correspond to 308 in method 300.

In 412A, the classification code recommendation system 40A outputs the at least one recommended classification code of the good or the service. This may correspond to 310 in method 300.

One skilled in the art appreciates that operation 400A is merely an example and that various modifications and/or variations to operation 400A to provide other embodiments.

FIG. 4B illustrates operation 400B of a classification code recommendation system 40B in one embodiment. The classification code recommendation system 40B may be implemented using at least one or more processors.

The classification code recommendation system 40B is generally the same as the classification code recommendation system 40A, except that the classification code recommendation system 40B includes the natural language processing model.

In 402B, the classification code recommendation system 40B receives a textual prompt associated with a good or a service. This may correspond to 302 in method 300.

In 404B, the classification code recommendation system 40B, based on the received textual prompt, transmits an information retrieval request to a classification codes information source (one or more database such as vector database).

In 406B, the classification codes information source obtains the corresponding information for classifying the good or the service, and provides the information to the classification code recommendation system 40B. In other words, the classification code recommendation system 40B retrieves information for classifying the good or the service from the classification codes information source. This may correspond to 304 in method 300.

The classification code recommendation system 40B then generates an input for a natural language processing model based on the textual prompt and the retrieved information. This may correspond to 306 in method 300. The classification code recommendation system 40B feeds the input to the natural language processing model. The natural language processing model processes the input and generates an output. The output includes at least one recommended classification code of the good or the service. The classification code recommendation system 40B obtains the output which includes the at least one recommended classification code of the good or the service. This may correspond to 308 in method 300.

In 408B, the classification code recommendation system 40B outputs the at least one recommended classification code of the good or the service. This may correspond to 310 in method 300.

One skilled in the art appreciates that operation 400B is merely an example and that various modifications and/or variations to operation 400B to provide other embodiments.

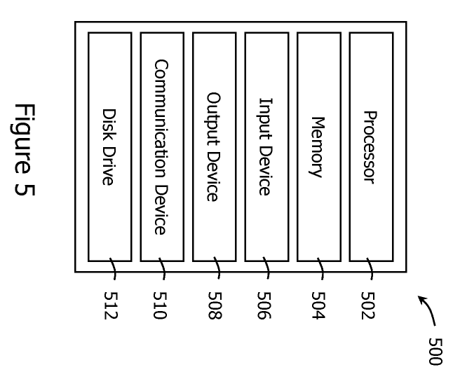

FIG. 5 shows an example information handling system 500 that can be used to implement some embodiments. For example, the information handling system 500 can be used to perform method 100. For example, the information handling system 500 can be used to perform method 300. For example, the information handling system 500 can be used to implement the recommendation system 20A, 20B, 40A, 40B. For example, the information handling system 500 can be used to operate the natural language processing model. For example, the information handling system 500 can be used to implement the information source (database).

The information handling system 500 includes suitable components necessary to receive, store, and execute appropriate computer instructions, commands, and/or codes. In this example, the information handling system 500 includes a processor 502 and a memory 504. The processor 502 may include one or more of: CPU(s), MCU(s), GPU(s), NPU(s), VPU(s), TPU(s), logic circuit(s), Raspberry Pi chip(s), digital signal processor(s) (DSP), application-specific integrated circuit(s) (ASIC), field-programmable gate array(s) (FPGA), and digital and/or analog circuitry (or circuitries) configured to interpret program instructions, to execute program instructions, and/or to process signals and/or information and/or data. The memory 504 may include one or more volatile memory (such as RAM, DRAM, SRAM, etc.), one or more non-volatile memory (such as ROM, PROM, EPROM, EEPROM, FRAM, MRAM, FLASH, SSD, NAND, NVDIMM, etc.), or any of their combinations. Appropriate computer instructions, commands, codes, information and/or data are stored in the memory 504. For example, computer instructions for performing the steps or operations of the method embodiments may be stored in the memory 504. The processor 502 and memory 504 may be integrated, or they may be separated and operably connected.

Optionally, the information handling system 500 further includes one or more input devices 506. Examples of the input device 506 include: keyboard, mouse, stylus, image scanner, microphone, tactile/touch input device (e.g., touch sensitive screen), image/video input device (e.g., camera), etc. The image/video input device can be used to capture an image of the good or service.

Optionally, the information handling system 500 further includes one or more output devices 508. Examples of the output device 508 include: display (e.g., monitor, screen, projector, etc.), speaker, headphone, earphone, printer, additive manufacturing machine (e.g., 3D printer), etc. The display may include an LCD display, a LED/OLED display, or other suitable display, which may or may not be touch sensitive.

The information handling system 500 may further include one or more disk drives 512 which may include one or more of: solid state drive, hard disk drive, optical drive, flash drive, magnetic tape drive, etc. A suitable operating system may be installed in the information handling system 500, e.g., on the disk drive 512 or in the memory 504. The memory 504 and the disk drive 512 may be operated by the processor 502.

Optionally, the information handling system 500 also includes a communication device 510 for establishing one or more communication links with one or more other computing devices, such as servers, personal computers, terminals, tablets, phones, watches, IoT devices, or other wireless computing devices. The communication device 510 may include one or more of: a modem, a Network Interface Card (NIC), an integrated network interface, a NFC transceiver, a ZigBee transceiver, a Wi-Fi transceiver, a Bluetooth® transceiver, a radio frequency transceiver, a cellular (2G, 3G, 4G, 5G, 6G, etc.) transceiver, an optical port, an infrared port, a USB connection, or other wired or wireless communication interfaces. Transceiver may be implemented by one or more devices (integrated transmitter(s) and receiver(s), separate transmitter(s) and receiver(s), etc.). The communication link(s) may be wired or wireless for communicating commands, instructions, information and/or data. In one example, the processor 502, the memory 504 (optionally the input device(s) 506, the output device(s) 508, the communication device(s) 510 and the disk drive(s) 512, if present) are connected with each other, directly or indirectly, through a bus, a Peripheral Component Interconnect (PCI), such as PCI Express, a Universal Serial Bus (USB), an optical bus, or other like bus structure. In one embodiment, at least some of these components may be connected wirelessly, e.g., through a network, such as the Internet or a cloud computing network. One skilled in the art appreciates that the information handling system 500 is merely an example and that in other embodiments the information handling system 500 can have a different configuration (e.g., with additional components, fewer components, alternative components, etc.).

Although not required, the embodiments described with reference to the Figures can be implemented as an application programming interface (API) or as a series of libraries for use by a developer or can be included within another software application, such as a terminal or computer operating system or a portable computing device operating system. Generally, as program modules include routines, programs, objects, components, and data files assisting in the performance of particular function, one skilled in the art will understand that the functionality of the software application may be distributed across a number of routines, objects, and/or components to achieve the same functionality desired herein.

It will also be appreciated that where the methods and systems of the invention are either wholly implemented by computing system or partly implemented by computing systems then any appropriate computing system architecture may be utilized. This will include stand-alone computers, network computers, dedicated or non-dedicated hardware devices. Where the terms “computing system” and “computing device” are used, these terms are intended to include any appropriate arrangement of computer or information processing hardware capable of implementing the function described.

Embodiments disclosed herein provide techniques for Harmonized System (HS) Code recommendation and classification code recommendation. For example, some embodiments disclosed herein provide an LLM-based classification code (e.g., HS Code) recommendation system and method. The LLM-based classification code (e.g., HS Code) recommendation system and method can support automatic identification of accurate HS Code. The system and method in some embodiments may support 6-digit HS Codes as well as 8-digit and 10-digit country-specific HS Codes, or more generally, any classification codes. Embodiments disclosed herein employ retrieval-augmented generation, which can be used to handle unstructured text and updates/changes to the classification code system (e.g., HS Code system).

One skilled in the art would appreciate that variations and/or modifications may be made to the disclosed embodiments to provide other embodiments. The disclosed embodiments should therefore be considered in all respects as illustrative, not restrictive. While some embodiments disclosed herein specifically relate to recommendation of HS Code, some other embodiments may relate to recommendation of other types of classification code.

1. A Harmonized System (HS) Code recommendation system, comprising:
one or more processors configured to:
receive a textual prompt associated with a good;
retrieve information for classifying the good based at least in part of the textual prompt;
generate an input for a natural language processing model based at least in part on the textual prompt and the retrieved information;
obtain an output based at least in part on applying the input to the natural language processing model, the output comprising at least one recommended HS Code of the good; and
output the at least one recommended HS Code of the good.

2. The HS Code recommendation system of claim 1, wherein the textual prompt comprises:
a description of the good; or
one or more keywords related to the good.

3. The HS Code recommendation system of claim 2, wherein the textual prompt further comprises a country or territory of interest associated with the recommendation.

4. The HS Code recommendation system of claim 3, wherein the information for classifying the good is retrieved from an information source comprising HS Codes information indexed based at least in part on a trie data structure.

5. The HS Code recommendation system of claim 1, wherein the information is retrieved from an information source comprising World Customs Organization (WCO) HS Codes information.

6. The HS Code recommendation system of claim 1, wherein the information is retrieved at least in part from the WCO Explanatory Notes.

7. The HS Code recommendation system of claim 1, wherein the information is retrieved from an information source comprising one or more country- or territory- specific HS Codes information.

8. The HS Code recommendation system of claim 1, wherein the information is retrieved from an information source comprising national or territorial tariff or customs information associated with country- or territory- specific HS Codes.

9. The HS Code recommendation system of claim 1, wherein the natural language processing model comprises a large language model (LLM).

10. The HS Code recommendation system of claim 1, wherein the one or more processors are configured to:
for each of the at least one recommended HS Code of the good:
retrieve a corresponding description of the recommended HS Code of the good; and
output the corresponding description of the recommended HS Code of the good.

11. The HS Code recommendation system of claim 1, wherein the one or more processors are configured to:
receive the textual prompt based at least in part on processing an image comprising the good.

12. The HS Code recommendation system of claim 1, wherein the recommended HS Code is a 6-digit code.

13. The HS Code recommendation system of claim 1, wherein the recommended HS Code is a 8-digit code or a 10-digit code.

14. A Harmonized System (HS) Code recommendation system, comprising:
one or more processors configured to:
receive a textual prompt comprising a description of a good, or one or more keywords related to the good;
retrieve, from an information source comprising HS Codes information indexed based at least in part on a trie data structure, information for classifying the good based at least in part of the textual prompt;
generate an input for a large language model based at least in part on the textual prompt and the retrieved information;
obtain an output based at least in part on applying the input to the large language model, the output comprising at least one recommended HS Code of the good; and
output the at least one recommended HS Code of the good.

15. A classification code recommendation system, comprising:
one or more processors configured to:
receive a textual prompt associated with a good or a service;
retrieve information for classifying the good or the service based at least in part of the textual prompt;
generate an input for a natural language processing model based at least in part on the textual prompt and the retrieved information;
obtain an output based at least in part on applying the input to the natural language processing model, the output comprising at least one recommended classification code of the good or the service; and
output the at least one recommended classification code of the good or the service.

16. The classification code recommendation system of claim 15, wherein the textual prompt comprises:
a description of the good or the service; or
one or more keywords related to the good or the service.

17. The classification code recommendation system of claim 16, wherein the textual prompt further comprises a country or territory of interest associated with the recommendation.

18. The classification code recommendation system of claim 17, wherein the information for classifying the good or the service is retrieved from an information source comprising classification codes information indexed based at least in part on a trie data structure.

19. The classification code recommendation system of claim 18, wherein the natural language processing model comprises a large language model (LLM).

20. The classification code recommendation system of claim 19, wherein the one or more processors are configured to:
for each of the at least one recommended classification code of the good or the service:
retrieve a corresponding description of the recommended classification code of the good or the service; and
output the corresponding description of the recommended classification code of the good or the service.
